(19) United States
(12) Patent Application Publication
(10) Pub. No.: US 2025/0155093 A1
(43) Pub. Date: May 15, 2025

(54) LIGHT PIPE

(71) Applicants: Miguel Cabada, Helotes, TX (US); Elio Cabada, Helotes, TX (US); Guillermo Cabada, Helotes, TX (US); Arturo Cabada, Helotes, TX (US)

(72) Inventors: Miguel Cabada, Helotes, TX (US); Elio Cabada, Helotes, TX (US); Guillermo Cabada, Helotes, TX (US); Arturo Cabada, Helotes, TX (US)

(21) Appl. No.: 18/778,941

(22) Filed: Jul. 20, 2024

Related U.S. Application Data
(60) Provisional application No. 63/528,031, filed on Jul. 20, 2023.

(51) Int. Cl. F21S 2/00; F21S 4/24; F21Y 115/10

(52) U.S. Cl. CPC F21S 2/005; F21S 4/24; F21Y 2115/10

(57) ABSTRACT

The present invention, therefore, provides systems and methods for a lighting structure system for LED lights. In an embodiment, the invention is a pipe system using a conical connection system impeded with an LED light limiting ribbon.

### CROSS-REFERENCE TO RELATED APPLICATIONS

This application claims the benefit under Title 35 United States Code § 119(e) of U.S. Provisional Patent Application Ser. No. 63/302,780; Filed: Jan. 25, 2022, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods for a lighting structure system. More specifically, the present invention relates to systems and methods for a lighting structure system for LED lights.

### BACKGROUND OF THE INVENTION

Without limiting the scope of the disclosed device, the background is described in connection with a lighting structure system.

The present invention offers a novel alternative to traditional lighting systems. Unlike conventional lighting systems which require special setups and connections in addition to being exposed and easily damages, the present device utilizes a load bearing truss pipe like housing with connectors on the end points, in an embodiment.

### BRIEF SUMMARY OF THE INVENTION

Accordingly, it is an object of the present invention to provide a load bearing lighting structure system which is easily deployable and configurable. It is a further object of the present invention to allow for the device to be utilized by an array of setup configurations.

In summary, the present invention discloses a novel device for a lighting structure system.

### DETAILED DESCRIPTION OF THE INVENTION

The present invention, therefore, provides systems and methods for a lighting structure system for LED lights. In an embodiment, the invention is a pipe system using a conical connection system impeded with an LED light limiting ribbon.

Disclosed herein in an embodiment is a lighting structure system that can be configured using different size pipe and connection models to assemble decorative lighting structures. For staging, temporary quick erected or permanent lighting structures are able to be assembled. The system in an embodiment, allows for mounting of other fixtures to the pipe and used as structure. The system may be used for staging and as decorative outdoor and indoor lighting structures.

The system allows for the transportation and implementation of LED ribbon in a rugged structure allowing for quick setup using simple hammer type tools. The system protects the LED, and allows for the quick implementation of the system in staging or decorative applications.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a perspective view of the light pipe in accordance with embodiments of the disclosure;

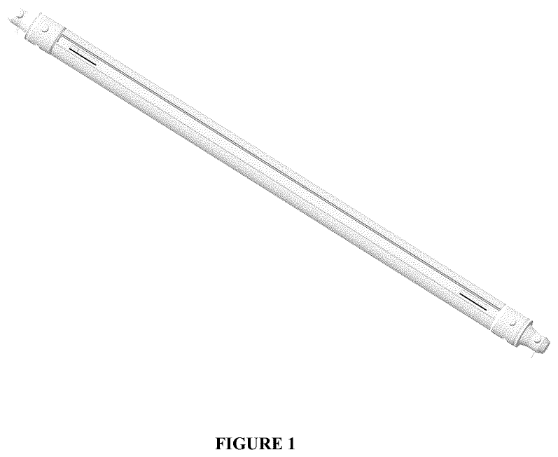

FIG. 2 is a line drawing perspective view of the light pipe in accordance with embodiments of the disclosure;

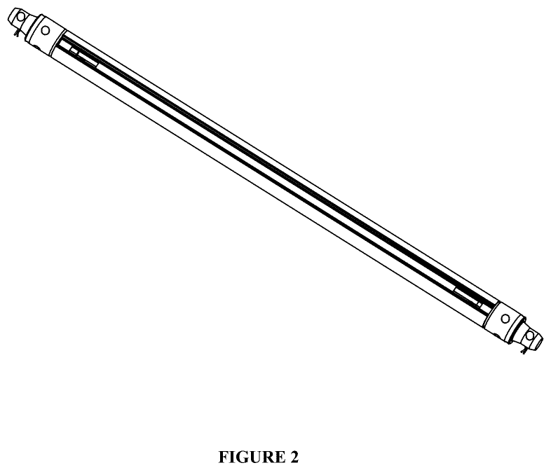

FIG. 3 is a see through perspective view of the light pipe in accordance with embodiments of the disclosure;

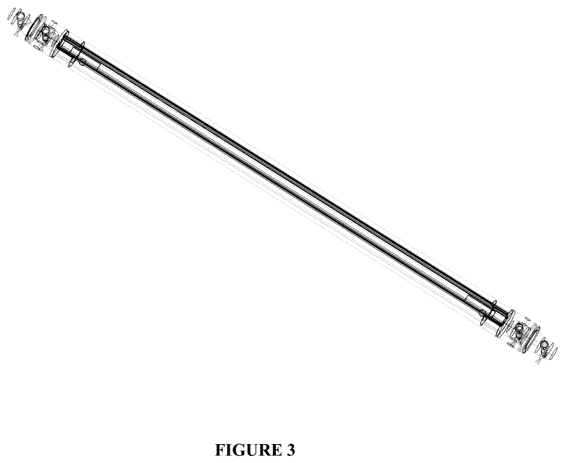

FIG. 4 is a top view of the light pipe in accordance with embodiments of the disclosure;

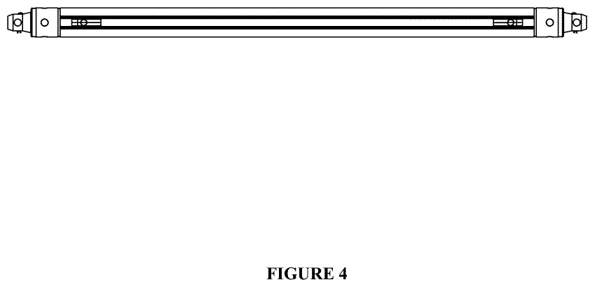

FIG. 5 is a side view of the light pipe in accordance with embodiments of the disclosure;

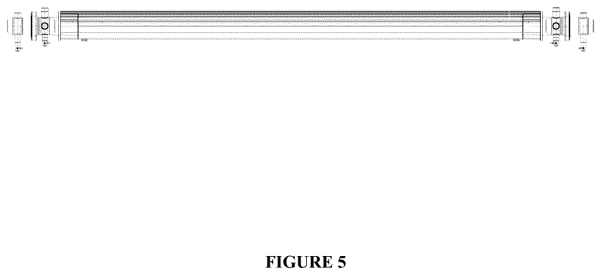

What is claimed is:

1. Systems and devices for a light pipe as disclosed herein.

2. Methods for a light pipe as disclosed herein.
